(19) United States
(12) Patent Application Publication
(10) Pub. No.: US 2025/0340165 A1
(43) Pub. Date: Nov. 6, 2025

(54) ILLUMINATED ROOF RACK RAIL

(71) Applicant: Sigma International, Livonia, MI (US)

(72) Inventors: Donald Bernier, Livonia, MI (US); Shahar Golan, Livonia, MI (US); Chris Naidoo, Livonia, MI (US); Michael Novak, Livonia, MI (US)

(73) Assignee: Sigma International, Livonia, MI (US)

(21) Appl. No.: 19/195,891

(22) Filed: May 1, 2025

Related U.S. Application Data
(60) Provisional application No. 63/641,475, filed on May 2, 2024.
(60) Provisional application No. 63/733,362, filed on Dec. 12, 2024.

(51) Int. Cl. B60Q 1/26; B60Q 1/44; B60Q 1/50; B60R 9/048

(52) U.S. Cl. CPC B60Q 1/2661; B60Q 1/44; B60Q 1/503; B60R 9/048; B60Q 2400/20

(57) ABSTRACT

A rail adapted for mounting on a vehicle equipped with an electrical harness. The rail includes a light emitting diode (LED) array comprising a plurality of LEDs, wiring to provide electrical communication with the vehicle electrical harness, a driver circuit to selectively activate individual LEDs of the plurality of LEDs, the driver circuit including software that provides for a plurality of lighting modes. The rail is configured to be mounted to a vehicle roof, running board, or lit badging.

### RELATED APPLICATIONS

This application claims priority benefit of U.S. Provisional Application Ser. No. 63/641,475 filed 2 May 2024 and U.S. Provisional Application Ser. No. 63/733,362 filed 12 Dec. 2024, the contents of which are hereby incorporated by reference

### FIELD OF THE INVENTION

The present invention in general relates to a vehicle roof racks, and, in particular to an illuminated roof rack in electrical communication with the vehicle electrical harness and able to display a variety of light-colors, patterns, or a combination thereof in order to enhance pedestrian safety and vehicle visibility.

### BACKGROUND OF THE INVENTION

In 2023, drivers struck and tragically killed 3,373 pedestrians in the United States during just the first half of the year. This alarming statistic reflects a growing crisis in pedestrian safety. Several contributing factors have been identified including: a significant drop in traffic enforcement across the country since 2020, enabling the rise of dangerous driving behaviors such as speeding and impaired driving; roadway designs that prioritize fast-moving vehicle traffic over safer conditions for pedestrians; a lack of sufficient infrastructure, including sidewalks, crosswalks, and lighting, which leaves pedestrians unprotected; a lack of sufficient infrastructure, including sidewalks, crosswalks, and lighting, which leaves pedestrians unprotected; and The increasing prevalence of larger, heavier vehicles in the U.S. vehicle fleet, which poses an inherently higher risk to pedestrians.

Given these circumstances, there is a critical need for vehicle-integrated safety features that actively assist in alerting pedestrians to a vehicle's presence-especially in urban, low-visibility, or high-traffic environments

Owing to the elevated position of a roof rack on a vehicle, it is particularly well suited for the inclusion of auxiliary lighting to enhance vehicle visibility. While enhanced visibility can afford safety and aesthetic attributes, conventional illuminated roof racks have met with limited acceptance owing to simplistic or even no operational software. As a result, lighting modes are limited and remote activation is not possible.

Given the state of the prior art, there exists an unmet need for an illuminated roof rack with software controlling operation thereof to provide a variety of lighting modes to enhance pedestrian safety and vehicle visibility. There further exists a need for an illuminated roof rack with a remote activation to facilitate, for example, lost vehicle location in a parking lot.

### SUMMARY OF THE INVENTION

The present invention provides a rail adapted for mounting on a vehicle equipped with an electrical harness. The rail includes a light emitting diode (LED) array comprising a plurality of LEDs, wiring to provide electrical communication with the vehicle electrical harness, a driver circuit to selectively activate individual LEDs of the plurality of LEDs, the driver circuit including software that provides for a plurality of lighting modes to enhance pedestrian safety and vehicle visibility

### BRIEF DESCRIPTION OF THE DRAWINGS

FIG. 1 is a perspective view of an inventive roof rack;

FIGS. 2A-2D are a sequence of successive partial illuminations of another embodiment of an inventive roof rack rail with a red light band progressing from rear (FIG. 2A) to intermediate positions (FIGS. 2B, C) to front (FIG. 2D);

FIG. 3 shows a first polychrome illumination across the rail shown in FIGS. 2A-2D;

FIG. 4 shows a second polychrome illumination across the rail shown in FIGS. 2A-2D;

FIG. 5 is a photograph showing two illuminated roof rack rails installed on a vehicle as part of a lighted roof rack including lighted cross members according to embodiments of the present invention;

FIG. 6 is a photograph showing two illuminated roof rack rails installed on a vehicle as part of a lighted roof rack including lighted cross members according to embodiments of the present invention;

FIG. 7 is a photograph showing two illuminated roof rack rails installed on a vehicle as part of a lighted roof rack including non-lighted cross members according to embodiments of the present invention;

FIG. 8 is a photograph showing two illuminated roof rack rails not installed on a vehicle as part of a lighted roof rack including cross members according to embodiments of the present invention;

FIG. 9 is a photograph showing two illuminated roof rack rails not installed on a vehicle as part of a lighted roof rack including cross members according to embodiments of the present invention;

FIG. 10 is a photograph showing an illuminated roof rack system installed on a vehicle according to embodiments of the present invention;

FIG. 11A is a photograph showing an illuminated roof rack rail installed on a vehicle according to embodiments of the present invention; and

FIG. 11B is a detailed view of the illuminated roof rack rail of FIG. 11A.

### DESCRIPTION OF THE INVENTION

The present invention has utility as a rail containing lights for mounting to a vehicle equipped with an electrical harness with software to control illumination as to color, sequence, or a combination thereof. By being remotely activated, the present invention is particularly useful in finding a lost vehicle and enhancing pedestrian safety and vehicle visibility. The present invention additionally has utility as a roof rack system configured to be positioned on the roof of a vehicle and to function as a useful fixture for the attachment of various objects thereto while also providing a compact, durable, and low-profile lighting solution optimized for enhancing pedestrian safety and vehicle visibility. The present invention directly addresses the growing need for improved vehicle-to-pedestrian communication. By combining a functional roof rack accessory with an integrated active safety lighting feature the system provides a practical, effective, and scalable solution to help reduce pedestrian injuries and fatalities.

The following detailed description is merely exemplary in nature and is in no way intended to limit the scope of the invention, its application, or uses, which may vary. The invention is described with relation to the non-limiting definitions and terminology included herein. These definitions and terminology are not designed to function as a limitation on the scope or practice of the invention but are presented for illustrative and descriptive purposes only.

It is to be understood that in instances where a range of values are provided that the range is intended to encompass not only the end point values of the range but also intermediate values of the range as explicitly being included within the range and varying by the last significant figure in the range. By way of example, a recited range from 1 to 4 is intended to include 1-2, 1-3, 2-4, 3-4, and 1-4.

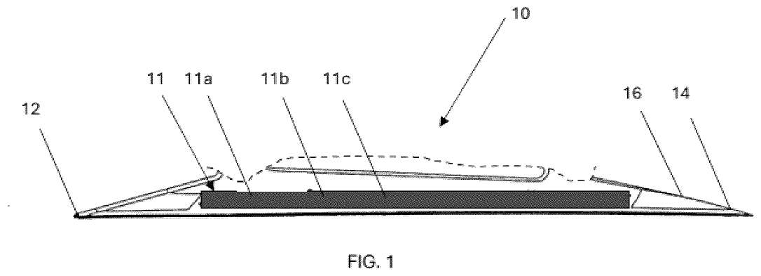

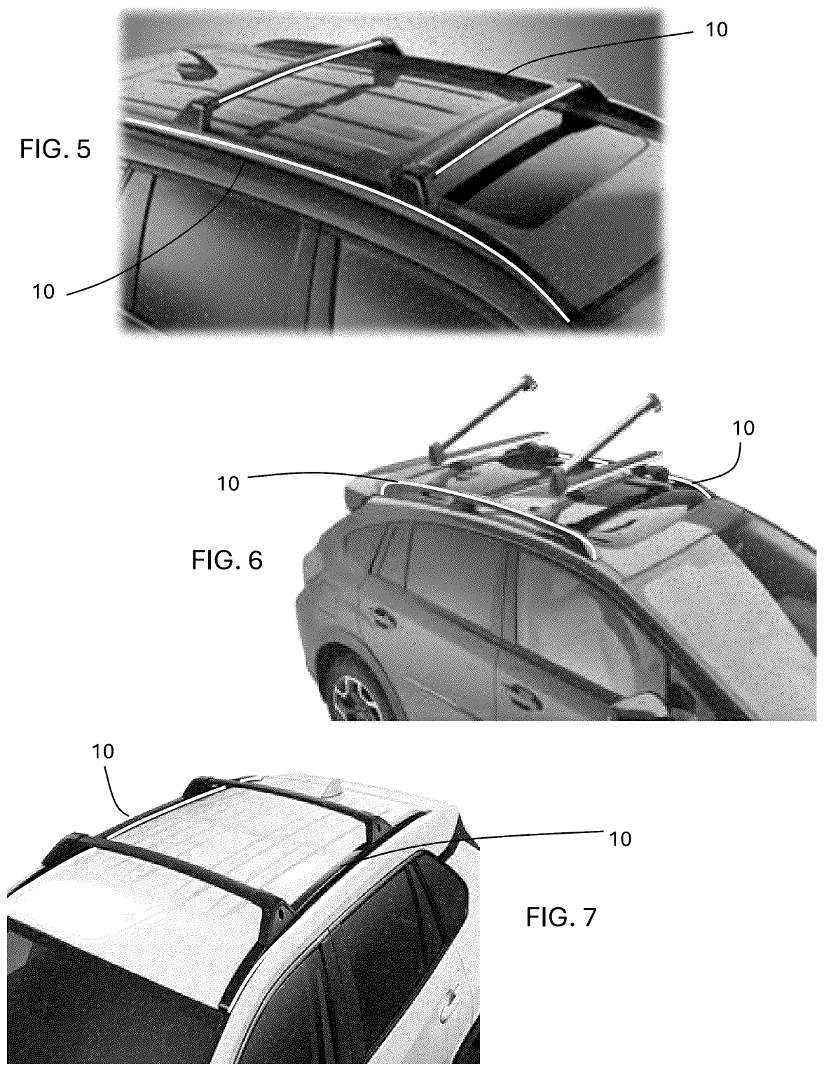

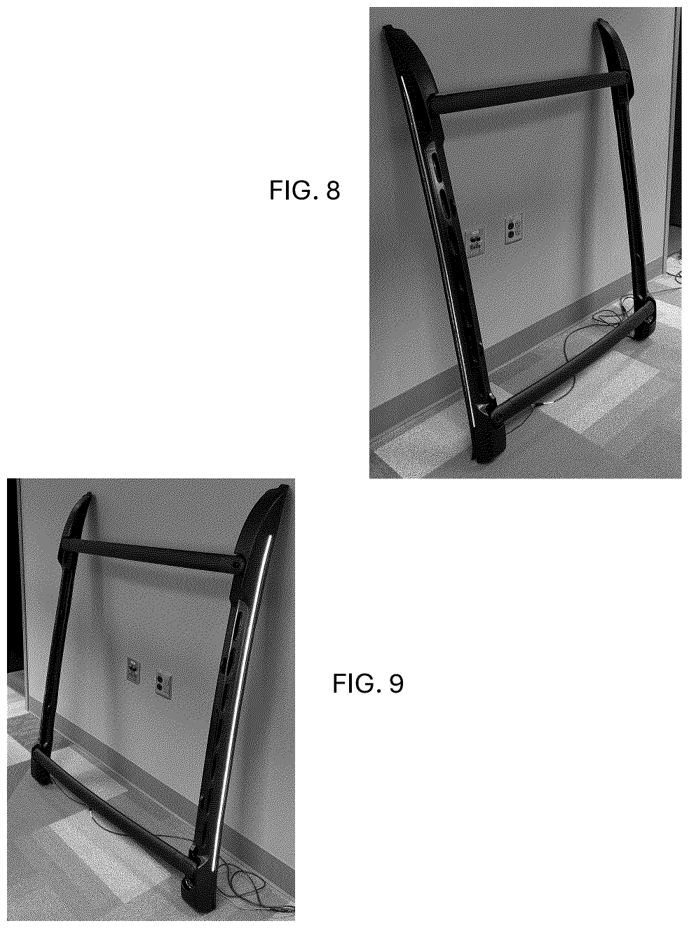

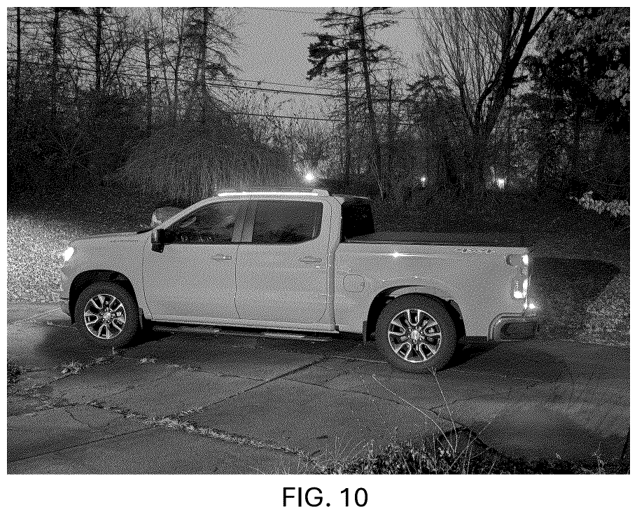

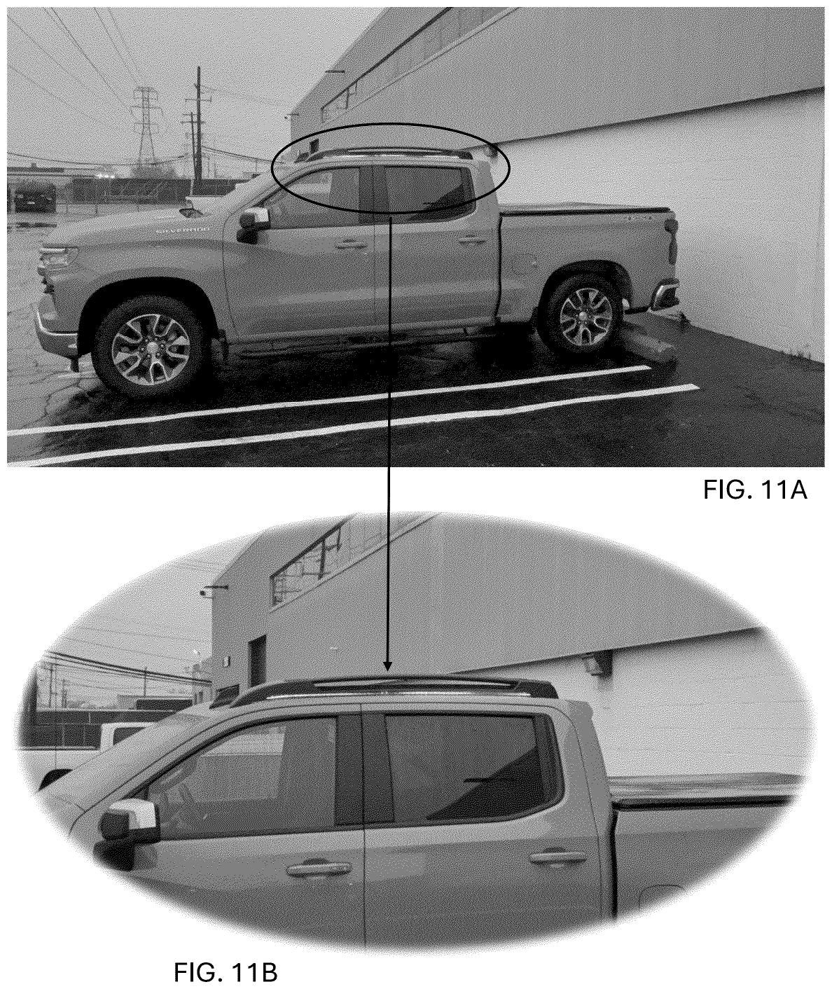

Referring to FIG. 1, a rail with a light emitting diode (LED) array for illumination is generally shown at 10. The light emitting diode (LED) array 11 includes a plurality of LEDs (11a, 11b, 11c). According to embodiments, the rail 10 is configured to be mounted to a roof of a vehicle on its own or as part of a roof rack system, according to various embodiments of the present invention. A complete luggage carrier/roof rack system, shown in FIGS. 5-7, includes two such spaced rails with the second rail being a mirror image of 10. The rail 10 is mounted generally parallel to each other and parallel to the lengthwise axis of the vehicle. The rail 10 has a front portion 12 positioned towards the front of the vehicle and a rear portion 14. Wiring is provided to provide electrical communication with the vehicle electrical harness. A driver circuit 16 is provided to selectively activate the array 11 and in particular individual LEDs 11a, 11b, 11c. The driver circuit, which according to embodiments in a printed circuit board, includes software that provides for user selected lighting modes, which enables high-intensity, energy-efficient, and uniform light emission. This board is integrated directly into the roof rack design, offering a compact, durable, and low-profile lighting solution optimized for automotive applications. In some inventive embodiments, the software also provides for automated activation, in for example, an emergency lighting mode of red lighting that is either static or dynamic when a collision or an airbag deployment occurs with the vehicle. It is appreciated that the driver 16 is alternately positioned in the vehicle.

In some inventive embodiments, roof rack rail 10 includes a braking lamp 16. Conventional tie-down holes and/or fixtures are provided in some inventive embodiments.

According to embodiments, the rail is provided as part of a roof rack of a vehicle, as part of a running board of a vehicle, as part of a lit badging system of a vehicle, or a combination thereof.

According to embodiments, the printed circuit board is fully sealed and designed for long-term durability under automotive environmental stresses, including vibration, moisture, temperature changes, and UV exposure.

The LED array 11 includes a series of separately addressable and activatable LEDs, light pipes, elongated light strip, or a combination thereof. As a result each LED of the array 11 is turned ON and OFF progressively and continuously one at a time or in small groups so that light from them appears to the viewer to travel along the side of the rail 11. It is appreciated that there may be more than one row and the rows may cross one another or be aligned in any pattern or direction or be located on the cross-bars as well as the sides so as to be noticeable in any or all directions. In some inventive embodiments, one or more the LEDs of the array 11 is polychromic and can provide a selectable color or LED emission, while in other embodiments, a cluster of LEDs, each emitting a different color, for example, red, yellow, blue, green, white, or any combination of the aforementioned colors is provided. According to embodiments, the rail is sealed such that water intrusion is prevented. According to embodiments the LEDs, light pipes, elongated light strip, or a combination thereof are high-intensity LEDs, making the lighting system capable of delivering headlight-level illumination, improving visibility and functionality. According to embodiments, the array of lighting elements includes a full LED matrix, enabling dynamic display of symbols, patterns, or words, significantly expanding communication capabilities.

According to embodiments, the LEDs, light pipes, elongated light strip, or a combination thereof are embedded within or affixed to the outer frame of the rail 10 of the roof rack and is configured to emit light outwardly and downwardly to enhance the lateral visibility of the vehicle from a pedestrian's point of view.

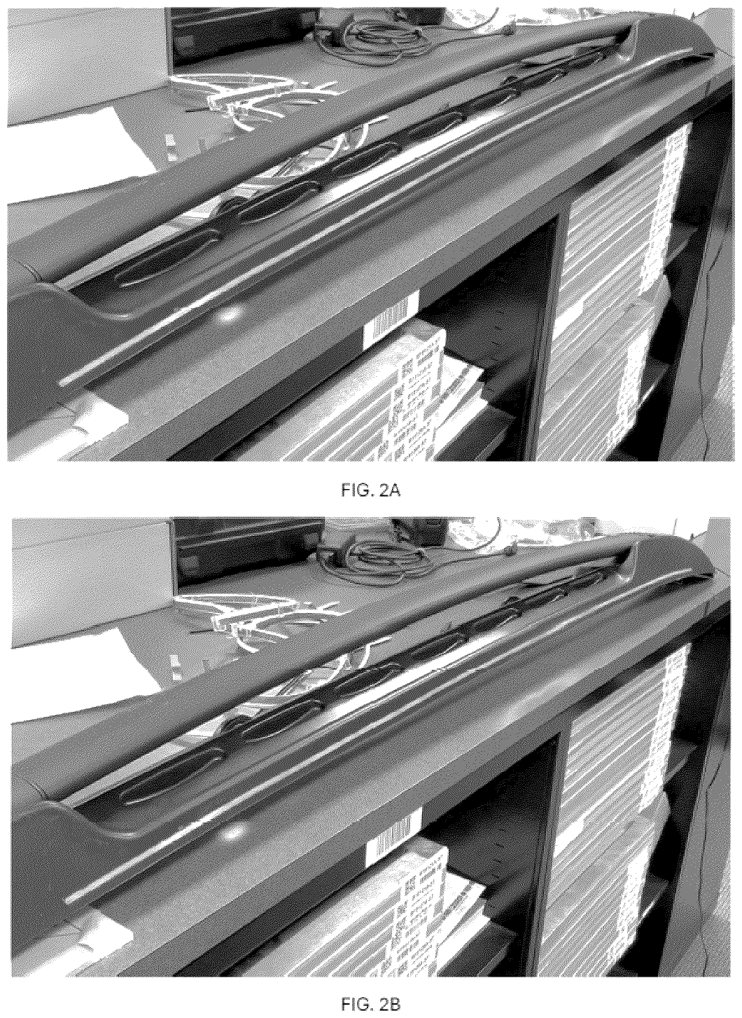

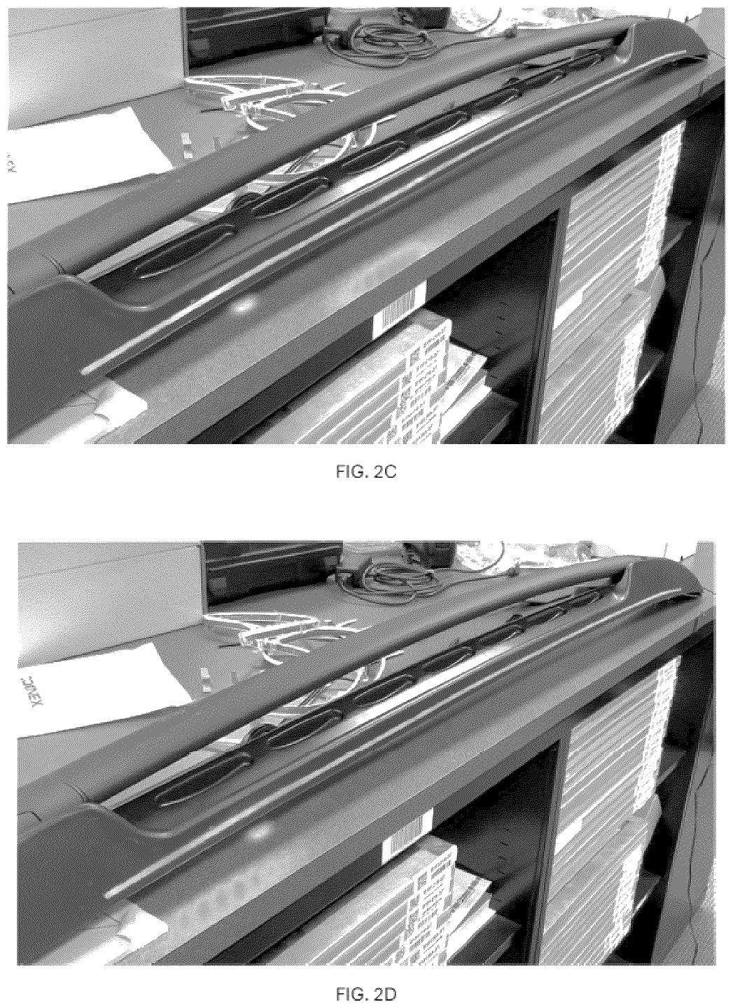

Examples of emissions are shown in FIGS. 2A-2D where an unaided, normal human eye observed a bar of red light formed by approximately 5 LEDs simultaneously emitting appears to travel from the back to the front of the rail.

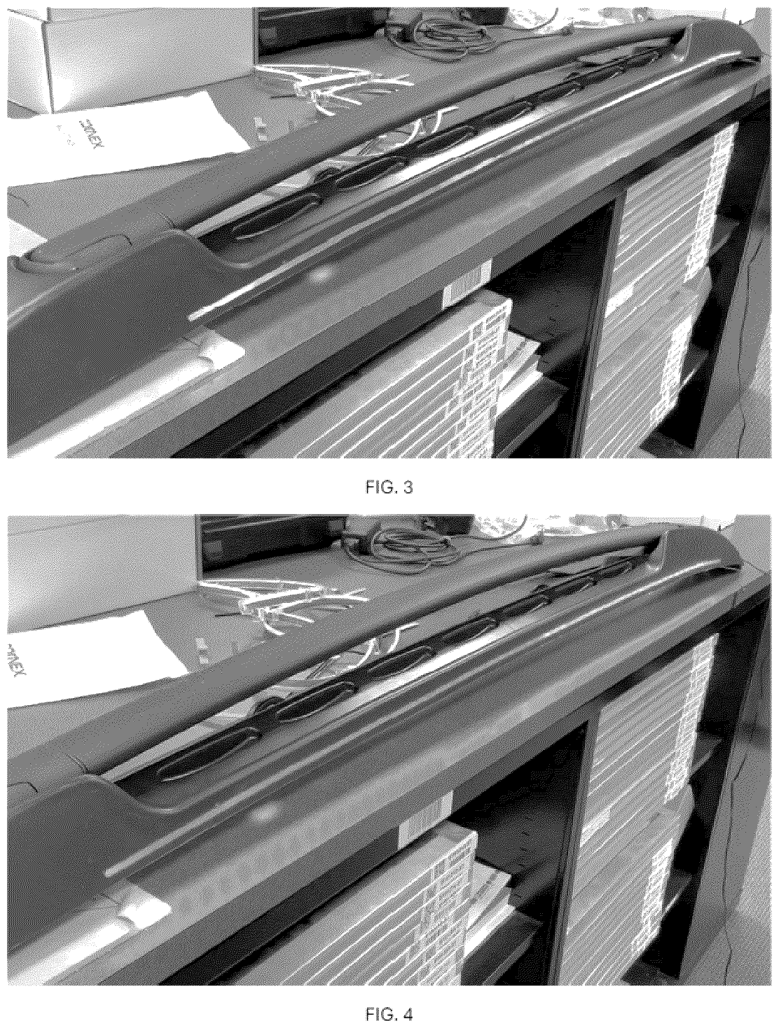

FIGS. 3 and 4 show different rainbow patterns emitted from the same rail as shown in FIGS. 2A-2D.

In some inventive embodiments, the LEDS are operated to spell words that for example include emergency messaging such as “CALL POLICE” or “SEND HELP.” Exemplary operational modes of the present invention illustratively include:
Flashing red—help me;
Flashing White (or custom color)—find my car in the parking lot;
Flashing amber—roadside hazard; and
Written messages.

According to embodiments, the various modes of the lighting system are provided as a set of pre-programmed lighting animations integrated and stored within the device for ease of access and use.

According to embodiments, the inventive rail or roof rack system include an active warning mode, in which when the vehicle is moving at low speeds, the light strip in the rail(s) can emit a pulsing or colored signal (such as amber or red) to indicate the vehicle's presence and movement, thereby enhancing pedestrian safety and vehicle visibility. According to embodiments, the lighting system is configured to interface with proximity sensors or ADAS (Advanced Driver Assistance Systems) to automatically activate when pedestrians or other objects are detected nearby. According to embodiments, the system is configured to adjust brightness of the lighting system based on environmental lighting conditions, providing optimal visibility during nighttime or low-light conditions. According to embodiments, the lighting is configured to synchronize with vehicle indicators such as turn signals, brakes, or hazard lights to provide additional visual cues to pedestrians and other vehicles.

According to embodiments, a smart phone application or an on board control unit is in electronic communication with the electronic driver and printed circuit board for controlling the lighting system of the inventive rail and roof rack system. The smart phone application or on board control unit provides a user interface to allow full customization and control of light behaviors and modes, similar to Apple Carplay.

In some inventive embodiments, a smart phone application or key fob is in electronic communication with the electronic driver such that a vehicle lost in a parking lot, can be activated to flash the LED array. As the inventive rail is elevated relative to headlights or taillights, it is easier to find the misplaced vehicle relative to conventional alert systems.

According to embodiments, the rail and roof rack system are provided with at least one solar panel to support partial or full power delivery, reducing dependency on vehicle power and improving energy efficiency.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments and those skilled in the art will recognize that modifications and changes can be made to the preferred embodiments of the invention without departing from the scope of this invention defined in the following claims.

1. A rail adapted for mounting on a vehicle equipped with an electrical harness, comprising:
a light emitting diode (LED) array comprising a plurality of LEDs affixed to an outer frame of the rail, wherein the outer frame of the rail is configured to be mounted to a roof of a vehicle;
wiring to provide electrical communication with the vehicle electrical harness,
a driver circuit to selectively activate individual LEDs of the plurality of LEDs, the driver circuit comprising software that provides for a plurality of lighting modes.

2. The rail of claim 1 wherein the frame of the rail is configured to be a mounted parallel to a lengthwise axis of the vehicle.

3. The rail of claim 1 wherein the plurality of LEDs form more than one row along a length of the LED array.

4. The rail of claim 1 wherein the plurality of LEDs are part of a light pipe, an elongated light strip, or a combination thereof.

5. The rail of claim 1 wherein the plurality of LEDs are high-intensity LEDs.

6. The rail of claim 1 wherein the driver circuit is a printed circuit board.

7. The rail of claim 1 wherein the printed circuit board is entirely sealed to be weatherproof.

8. The rail of claim 1 wherein the driver circuit is integrated into the frame of the rail.

9. The rail of claim 1 further comprising a controller operating with a key fob or smart phone app for remotely activating the driver circuit.

10. The rail of claim 1 further comprising an on board control unit configured to provide a user interface for controlling the driver circuit.

11. The rail of claim 1 wherein the plurality of lighting modes includes at least two of static, dynamic monochrome, dynamic polychrome, and message forming.

12. The rail of claim 1 wherein polychrome activation of the plurality of LEDs occurs and includes at least two colors from among: red, yellow, blue, green, and white.

13. The rail of claim 1 wherein the rail mounts to a vehicle roof, running board, or lit badging.

14. The rail of claim 1 further comprising a solar panel configured to at least partially power the plurality of LEDs of the rail.

15. A roof rack system comprising:
a first rail and a second rail of claim 1 configured to be mounted parallel to each other on a vehicle roof and parallel to a lengthwise axis of the vehicle.

16. The roof rack of claim 15 further comprising a braking lamp.

17. The roof rack of claim 15 further comprising a plurality of tie-down holes or fixtures.
